(19) United States
(12) Patent Application Publication
(10) Pub. No.: US 2017/0045309 A1
(43) Pub. Date: Feb. 16, 2017

(54) HIGH TEMPERATURE FLOW MANIFOLD

(71) Applicant: Hamilton Sundstrand Corporation, Charlotte, NC (US)

(72) Inventor: Gregory K. Schwalm, Avon, CT (US)

(21) Appl. No.: 14/823,309

(22) Filed: Aug. 11, 2015

(51) Int. Cl. F28F 9/02; B23P 15/26

(52) U.S. Cl. CPC F28F 9/0243; F28F 9/0275; B23P 15/26

(57) ABSTRACT

A manifold including a body defining a chamber configured to receive a fluid, the body having a plurality of apertures passing therethrough and a plurality of channels engaged in the apertures and configured to receive the fluid from the chamber, each of the plurality of channels having an end defining an inlet that is in fluid communication with the chamber. Each channel defines a standoff defining a portion of the channel that is not in contact with the body such that the inlet is separated from the body by a standoff distance along the length of the channel and the standoff distance is a distance that is one or more times a hydraulic diameter of the inlet.

### STATEMENT REGARDING FEDERALLY SPONSORED RESEARCH OR DEVELOPMENT

This invention was made with government support under Contract No. FA8650-09-D-2923 awarded by the United States Air Force. The government has certain rights in the invention.

### BACKGROUND

The subject matter disclosed herein generally relates to high temperature flow manifolds and, more particularly, to improved high temperature flow manifolds.

Flow manifolds may be used to collect, distribute, and/or enable the transfer of fluids within a system. Manifolds may be used for high temperature applications, such that high temperature fluids may be distributed into smaller channels, such as tubes, pipes, etc. For example, tube and shell heat exchangers may be used in high temperature applications because the channels can accommodate significant growth due to thermal expansion. Tube and shell heat exchanger designs utilize channels brazed into a hot inlet manifold such that the channel inlets are essentially flush with the inner surface of the manifold. The heat transfer coefficient in each channel may be much greater near the channel inlet (junction) than the developed heat transfer coefficient occurring a short distance into the channel. This design may result in a higher heat flux into the material of the channel near the channel inlet than into the adjacent manifold material, with resultant stresses in the channels at the channel-manifold junction when the channel and manifold materials are dissimilar or when the heat exchanger undergoes rapid thermal transients, i.e., the temperatures and/or flows through the heat exchanger vary rapidly with time. Undesirable stresses may be introduced in the channels at a channel-manifold junction when the material composition of the channel and the manifold constraining the channels are dissimilar.

### SUMMARY

According to one embodiment a manifold is provided. The manifold includes a body defining a chamber configured to receive a fluid, the body having a plurality of apertures passing therethrough and a plurality of channels engaged in the apertures and configured to receive the fluid from the chamber, each of the plurality of channels having an end defining an inlet that is in fluid communication with the chamber. Each channel defines a standoff defining a portion of the channel that is not in contact with the body such that the inlet is separated from the body by a standoff distance along the length of the channel. The standoff distance is a distance that is one or more times a hydraulic diameter of the inlet.

In addition to one or more of the features described above, or as an alternative, further embodiments may include a plurality of shorteners, each shortener coupled with a respective inlet of a channel of the plurality of channels, each shortener configured to reduce the hydraulic diameter of the channel at the inlet.

In addition to one or more of the features described above, or as an alternative, further embodiments may include that the plurality of shorteners are connected to form a sheet.

In addition to one or more of the features described above, or as an alternative, further embodiments may include that each shortener is integrally formed with the respective channel.

In addition to one or more of the features described above, or as an alternative, further embodiments may include that the standoff is a section of channel that extends the standoff distance from a surface of the body.

In addition to one or more of the features described above, or as an alternative, further embodiments may include that the standoff is at least partially defined by a standoff gap formed between an outer surface of the channel and the aperture.

In addition to one or more of the features described above, or as an alternative, further embodiments may include that the channel comprises a reduced width portion, wherein the reduced width portion has a width that is smaller than a width of a respective aperture and the length of the reduced width portion is the standoff distance, wherein the standoff gap is formed between the reduced width portion and the aperture.

In addition to one or more of the features described above, or as an alternative, further embodiments may include that the inlet of the channel is level with a surface of the body.

In addition to one or more of the features described above, or as an alternative, further embodiments may include that each aperture defines a first portion having a first aperture width and a second portion having a second aperture width, wherein the first aperture width is larger than the outer surface of a respective channel, wherein the standoff gap is formed between the outer surface of the channel and the first portion.

In addition to one or more of the features described above, or as an alternative, further embodiments may include that the first portion has a length equal to the standoff distance.

In addition to one or more of the features described above, or as an alternative, further embodiments may include that the outer surface of the channel and the aperture have the same geometric shape.

In addition to one or more of the features described above, or as an alternative, further embodiments may include that the standoff distance is a distance that is between three and six times a hydraulic diameter of the inlet.

In addition to one or more of the features described above, or as an alternative, further embodiments may include that the body forms a manifold of a shell and tube heat exchanger and the channels form the tubes of the shell and tube heat exchanger.

According to another embodiment, a method of manufacturing a manifold is provided. The method includes providing a body defining a chamber configured to receive a fluid and having a plurality of apertures passing therethrough and installing a plurality of channels to engage with the apertures, each of the plurality of channels having an end defining an inlet that is in fluid communication with the chamber. As installed, each channel defines a standoff defining a portion of the channel that is not in contact with the body such that the inlet is separated from the manifold by a standoff distance along the length of the channel. The standoff distance is a distance that is one or more times a hydraulic diameter of the inlet.

In addition to one or more of the features described above, or as an alternative, further embodiments may include installing a plurality of shorteners at the inlet of each channel, the shorteners configured to reduce the hydraulic diameter of the channel at the inlet.

In addition to one or more of the features described above, or as an alternative, further embodiments may include that the plurality of shorteners are each connected to form a sheet, the method comprising installing the sheet into the manifold.

In addition to one or more of the features described above, or as an alternative, further embodiments may include that the standoff is a section of channel that extends the standoff distance from a surface of the body.

In addition to one or more of the features described above, or as an alternative, further embodiments may include that the standoff is at least partially defined by a standoff gap formed between an outer surface of the channel and the aperture.

In addition to one or more of the features described above, or as an alternative, further embodiments may include that the inlet of the channel is level with a surface of the body.

In addition to one or more of the features described above, or as an alternative, further embodiments may include that the body is a manifold for a shell and tube heat exchanger and the channels are the tubes of the shell and tube heat exchanger.

Technical effects of embodiments of the present disclosure include reducing thermal stresses near a channel-manifold interface in a manifold. Further technical effects of embodiments include offsetting a channel inlet from a manifold interface and/or decreasing the hydraulic diameter of a channel at the channel inlet to reduce the length of offset.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of a shell and tube heat exchanger manifold-channel interface in accordance with a traditional configuration;

FIG. 2 is a schematic illustration of a shell and tube heat exchanger manifold-channel interface in accordance with an example embodiment of the present disclosure;

FIG. 3 is a schematic illustration of a channel standoff in accordance with an example embodiment of the present disclosure;

FIG. 4 is a schematic illustration of a channel standoff in accordance with another example embodiment of the present disclosure;

FIG. 5 is a schematic illustration of a channel standoff in accordance with another example embodiment of the present disclosure;

FIG. 6A is a schematic illustration of a shortener in accordance with an example embodiment of the present disclosure;

FIG. 6B is a schematic illustration of a shortener in accordance with another example embodiment of the present disclosure;

FIG. 6C is a schematic illustration of a shortener in accordance with another example embodiment of the present disclosure;

FIG. 7A is a schematic plan illustration of a shortener sheet in accordance with an example embodiment of the present disclosure;

FIG. 7B is a schematic side-view illustration of the shortener sheet of FIG. 7A; and

FIG. 8 is a process of manufacturing a manifold in accordance with an example embodiment of the present disclosure.

### DETAILED DESCRIPTION

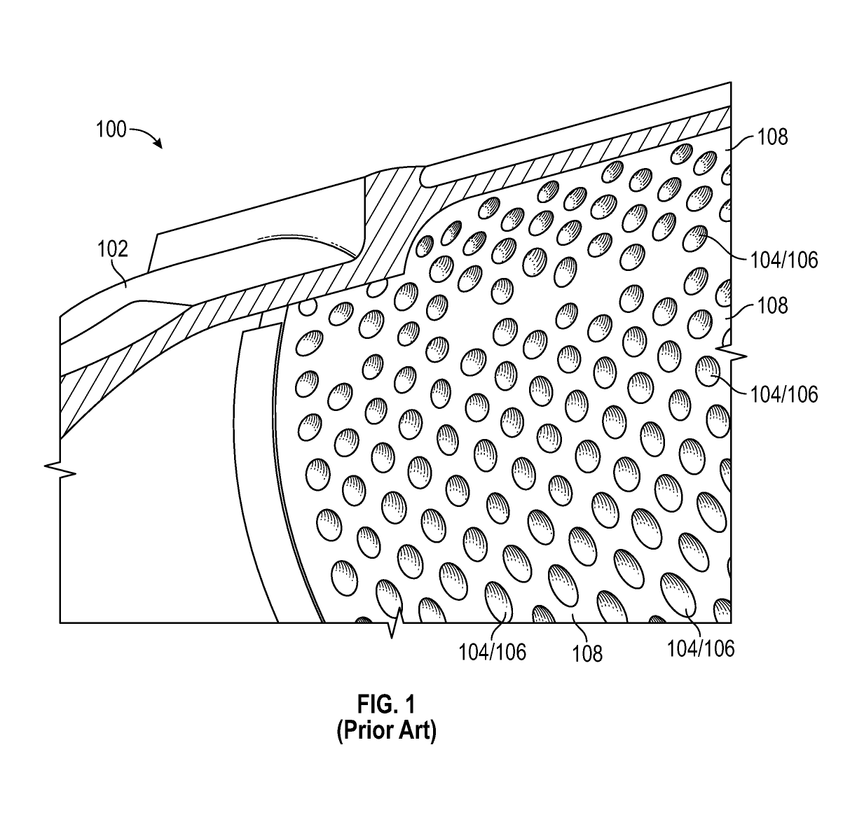

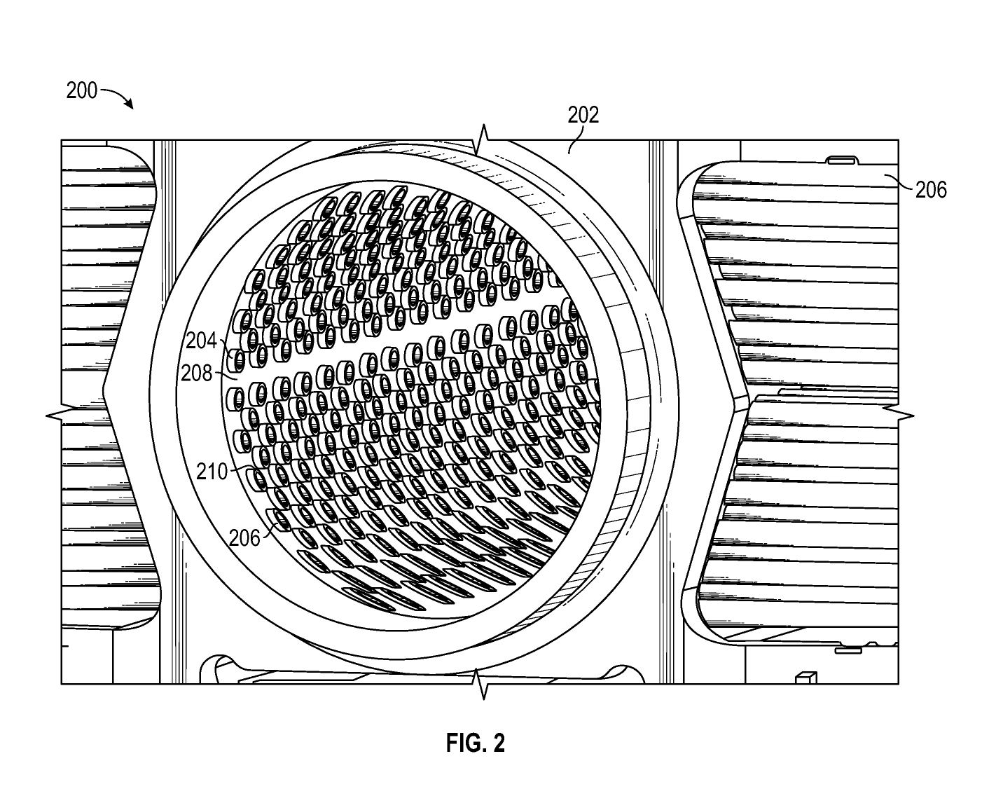

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. 1 may be labeled “1a” and a similar feature in FIG. 2 may be labeled “2a.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

As described herein, improved manifolds and characteristics thereof will be described with respect to a number of embodiments. However, those of skill in the art will appreciate that the various embodiments are non-limiting and the concepts and principles described may be applied to other configurations, devices, and/or systems. For example, described below are variations and embodiments of shell and tube heat exchangers. However, various concepts described with respect to the manifold of the heat exchanger may be applied to other manifolds, i.e., the application is not limited to heat exchanger manifolds.

FIG. 1 is a partial view of a manifold having a traditional configuration. The manifold 100 includes a body 102 which includes a plurality of apertures 104 passing therethrough. The body 102 defines a chamber or cavity therein. Engaged with and installed into the apertures 104 are a respective number of channels 106. The channels 106 may be configured as tubes, pipes, or other elements configured to enable the passage of fluids therethrough. The channels 106 may be brazed to the apertures 104 or otherwise attached and/or connected to the body 102. In operation a fluid may enter the chamber of the body 102 and then flow into the channels 106. As shown in FIG. 1, the channels 106 are flush or substantially flush with an interface surface 108 of the body 102. Those of skill in the art will appreciate that the channels 106 may extend slightly into the body 102 of the manifold 100 as a result of the manufacturing process.

As noted, the channels 106 are brazed into the body 102 and flush with the interface surface 108 at each aperture 104 such that inlets to the channels are flush with the interface surface 108 of the body 102. During operation, the heat transfer coefficient in each channel 106 may be much greater near the channel inlet, i.e., at the interface surface 108, than the developed heat transfer coefficient occurring a short distance into the channel 106, i.e., away from the interface surface 108. As a result, a high heat flux may be generated near the channel inlet with resultant stresses in the channels 106 at the interface surface 108, i.e., at a channel-manifold junction. If the channel and manifold materials are dissimilar and/or when the manifold undergoes rapid thermal transients, i.e., the temperatures and/or flows through the manifold vary rapidly with time, the stresses may be greatest. This may be further exacerbated due to a lower heat flux generated into the interface surface 108 and the body 102. That is, the heat flux of the channels 106 may be different than that of the material of the body 102, and thus thermal and mechanical stresses may arise based on the thermal expansion or contraction of either or both of the channels 106 and/or the body 102.

For example, if the channels 106 expand or contract at a faster rate than the material to which they are brazed, i.e., the interface surface 108 and body 102, the connection or brazing between the two elements may undergo stresses. Over time this may result in cracks and/or separation, of the braze material or the material of the channels and/or manifold, which may result in a leak, thus damaging the manifold 100.

Turning now to FIG. 2, a manifold in accordance with an example embodiment of the present disclosure is shown. The manifold 200 may be similar to manifold 100 of FIG. 1. However, in the manifold 200, the channels 206 pass through the apertures 204 and extend from the interface surface 208 of the body 202, thus forming a standoff that is greater than that formed during the manufacturing process, as discussed above.

The standoff of the channels 206 may reduce thermal stresses near the channel/manifold interface, i.e., at the interface surface 208, by placing the channel inlet 210 far enough from the interface surface 208 to significantly reduce the heat flux into the material of the channels 206 at the interface surface 208. Although the heat transfer coefficient at the channel inlet 210 may remain high, the heat flux into the channel/manifold junction is reduced compared to the configuration shown in FIG. 1. This is because heat must conduct along the extended channel length (standoff distance) from the inlet 210 to the interface surface 208. Furthermore, although the heat transfer coefficient may still be high at the channel inlet 210, the heat flux may be reduced because the temperature difference between the fluid entering the channel 206 and the channel wall at the inlet is reduced because the channel wall at the inlet is contacted by fluid in the body 202 on both the inside and outside. The reduction in heat flux into the channel/manifold junction may be achieved by various mechanisms as described herein. As shown in FIG. 2, one solution of the present disclosure is to configure the channels 206 to extend beyond the manifold inner surface (interface surface 208) such that a standoff of the channel is formed or present that extends a standoff distance that is greater than the former manufacturing techniques and processes.

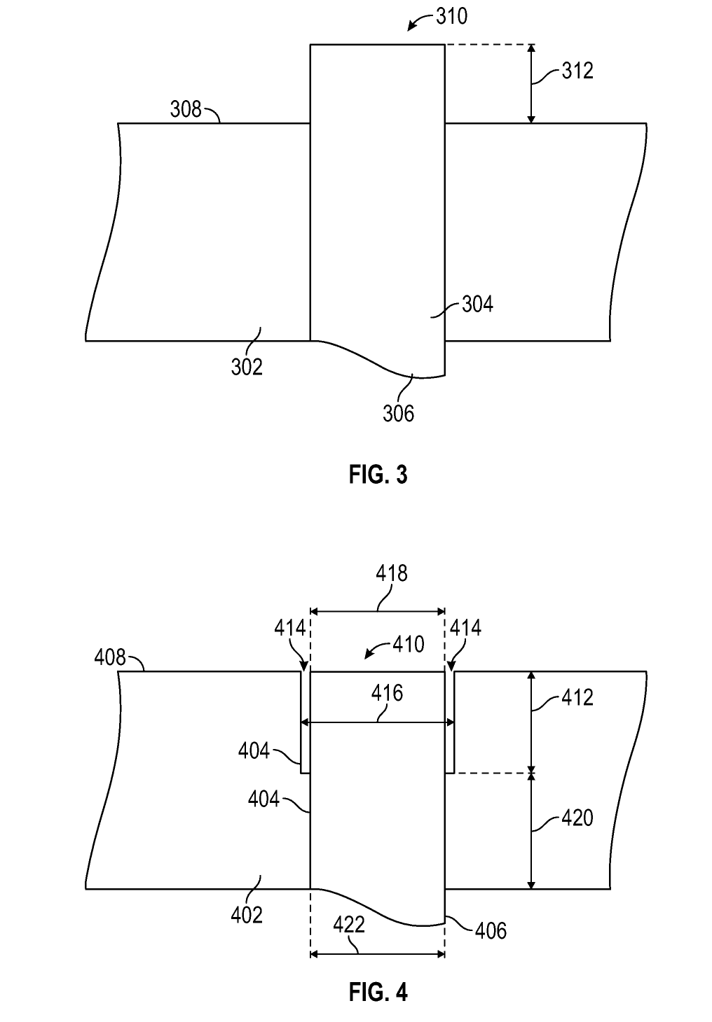

Turning to FIG. 3, a more detailed view of a channel standoff in accordance with an example embodiment is shown. The standoff may be similar to that shown in FIG. 2. For example, a channel 306 be located within an aperture 304 of a manifold body 302 and may extend out of the body 302 beyond an interface surface 308. As a result, the inlet 310 of the channel 306 may be located a standoff distance 312 from the interface surface 308. The standoff distance 312 defines the standoff. As will be appreciated by those of skill in the art, the standoff distance 312 may be varied and configured based on the specific configuration of the manifold or based on other considerations. In this embodiment, and the embodiments described below, the primary consideration is the separation of the material of the channel at the channel inlet from the material of the manifold, i.e., the portion of the channel that is subject to the highest thermal stresses. As shown in FIG. 3, the aperture 304 may have width that is similar to the width of the channel, such that an interference fit is formed or a minimal gap may be formed for braze material to be deposited and brazed.

Turning to FIG. 4, an alternative configuration in accordance with an example embodiment is shown. In the configuration of FIG. 4, the inlet 410 of the channel 406 is flush or level with the interface surface 408 of the manifold body 402. However, a portion of the channel 406 near the inlet is still separated from material of the body 402 and exposed for a standoff distance 412. To achieve the standoff distance 412, a standoff gap 414 is formed around the inlet end of the channel 406. That is, a first aperture width 416 of the aperture 404 is larger than an outer width 418 of the channel 406. The standoff gap 414 is formed by the first aperture width 416 extending for the standoff distance 412 from the interface surface 408.

It will be appreciated by those of skill in the art that the manifold junction width 416 does not extend for the entire thickness of the body 402. Rather, a portion 420 of the aperture 404 through the body 402 will have a second aperture width 422 that is substantially the same as the outer width 418 of the channel 406. Substantially the same widths, as used herein, may mean that the widths are the same, or close enough to form an interference fit, or have a small separation between the two surfaces for brazing material, depending on the desired configuration. In some embodiments, a small air gap may be formed between the channel 406 and the body 402 such that a braze material may be supplied and the channel 406 and the body 402 may be brazed together. In some such embodiments, the braze material may not be supplied or at least may not interfere with the standoff gap 414. In some embodiments, the first aperture width 416 of the body 402 that is larger than the channel width 418 may be formed by a counter-bore or other machining.

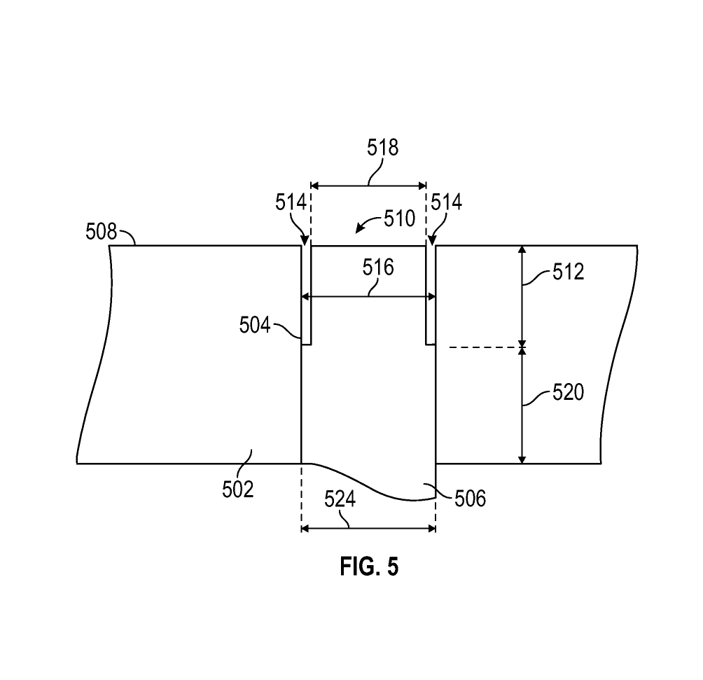

Turning to FIG. 5, an alternative configuration in accordance with an example embodiment is shown. In the configuration of FIG. 5, similar to the configuration of FIG. 4, the inlet 510 of the channel 506 is flush or level with the interface surface 508 of the manifold body 502. A portion of the channel 506 is exposed for a standoff distance 512 from the interface surface 508. To achieve the standoff distance 512, a standoff gap 514 is formed around the inlet end of the channel 506. That is, an aperture width 516 is larger than a channel first outer width 518 of the channel 504 at the inlet 510. In this embodiment, the standoff gap 514 is formed by the smaller channel first outer width 516 for the standoff distance 512. In this embodiment, rather than an increased width of the aperture 504 at the junction with the channel 506, the channel 506 has a channel first outer width 518 that is smaller than the aperture width 516 proximal to the inlet 510. The channel first outer width 518 extends for a length equal to the standoff distance 512. As shown in FIG. 5, after the standoff distance 512, the aperture width 516 and a channel second outer width 524 are similar.

Similar to the embodiment of FIG. 4, it will be appreciated by those of skill in the art that the channel first outer width 518 of the channel 506 does not extend for the entire thickness of the body 502. That is, a portion 520 of the channel 506 will have a width 524 that is substantially the same as the aperture width 516. As described above, substantially the same widths, as used herein, may mean that the widths are the same, or close enough to form an interference fit or have a small amount of air present between the two surfaces, depending on the desired configuration. In some embodiments, a small air gap may be formed between the channel 506 and the aperture 504 such that a braze material may be supplied and the two elements may be brazed together. In some such embodiments, the braze material may not be supplied or at least may not interfere with the standoff gap 514.

In any of the above example embodiments, or variations thereof, the standoff distance (312, 412, 512) may be a function of the hydraulic diameter. In some embodiments, the standoff distance may be equal to one or more times the hydraulic diameter of the channel. Further, in some embodiments, the standoff distance may be equal to a length that is three to six times the hydraulic diameter of the channel. Due to increased weight and/or structural considerations, it may be desirable to minimize the standoff distance while maximizing the thermal benefits. Further, those of skill in the art will appreciate that variations or combinations of the non-limiting embodiments shown in FIGS. 3-5 may be employed without departing from the scope of the present disclosure. For example, in some embodiments, a configuration may include both a standoff of the channel from or above the manifold surface (e.g., FIG. 3) and also include a counter-bore (e.g., FIG. 4) and/or a narrowed width end of the channel (e.g., FIG. 5).

Further, those of skill in the art will appreciate that the standoff gap (414, 514) may not be a circumferential standoff gap. That is, in some embodiments, the channels may not be circular but rather may be square, rectangular, or have another geometric shape. As such, the above described “widths” may refer to a width or other dimension of the channel and/or aperture. As such, the standoff gap is not limited to a circumferential or circular gap, but rather, the standoff gap is a volume or space formed between an exterior or outer surface of the channel and an interior surface of an aperture that is formed in the manifold. In some non-limiting embodiments, the geometric shape of the channel and the geometric shape of the aperture may be the same, and in other non-limiting embodiments, the two geometric shapes may be different. Those of skill in the art will appreciate that additive manufacturing techniques may be used to form any desired configuration, while forming a gap between a surface of a channel and a surface of the manifold, without departing from the scope of the disclosure. The standoff gap may be any size, or distance, extending between the channel and the aperture. In some embodiments, the standoff gap may be configured to provide a volume between a surface of the channel and the aperture wherein a fluid within the manifold may enter the volume.

A flow recirculation zone may form at the channel inlet that may result in a high heat transfer coefficient region starting just beyond the recirculation zone instead of exactly at the channel inlet. This may result in a larger increased standoff distance to achieve optimal pressure drop and flow distribution across a hot inlet manifold to thus provide the thermal benefits described above. Because the length of the region with high heat transfer coefficient and the distance of this zone from the channel inlet due to recirculation are functions of the hydraulic diameter of the hot flow passages, the region of high heat transfer coefficient can moved or forced closer to the channel inlet, i.e., the standoff distance can be shortened by incorporating a feature that results in multiple flow channels for a short distance near the channel inlet, each with reduced hydraulic diameter.

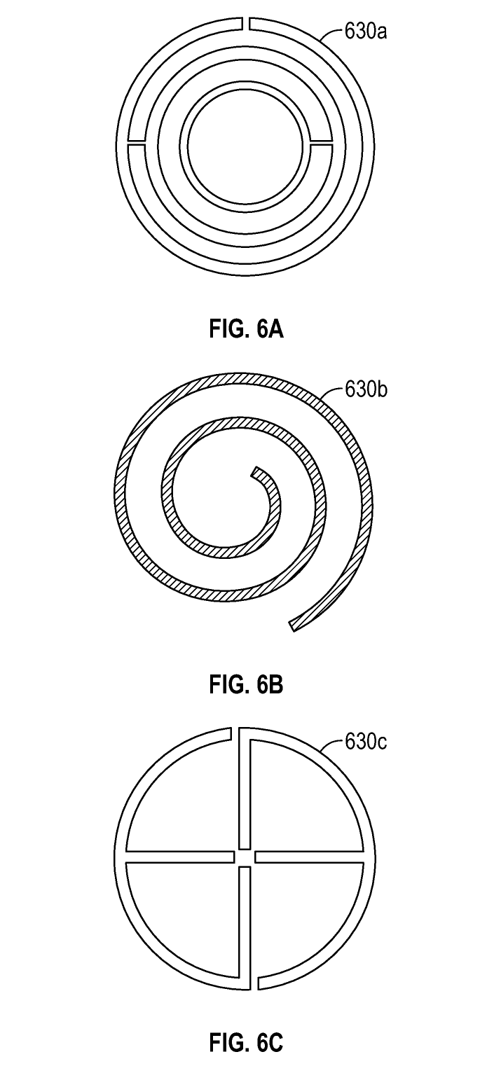

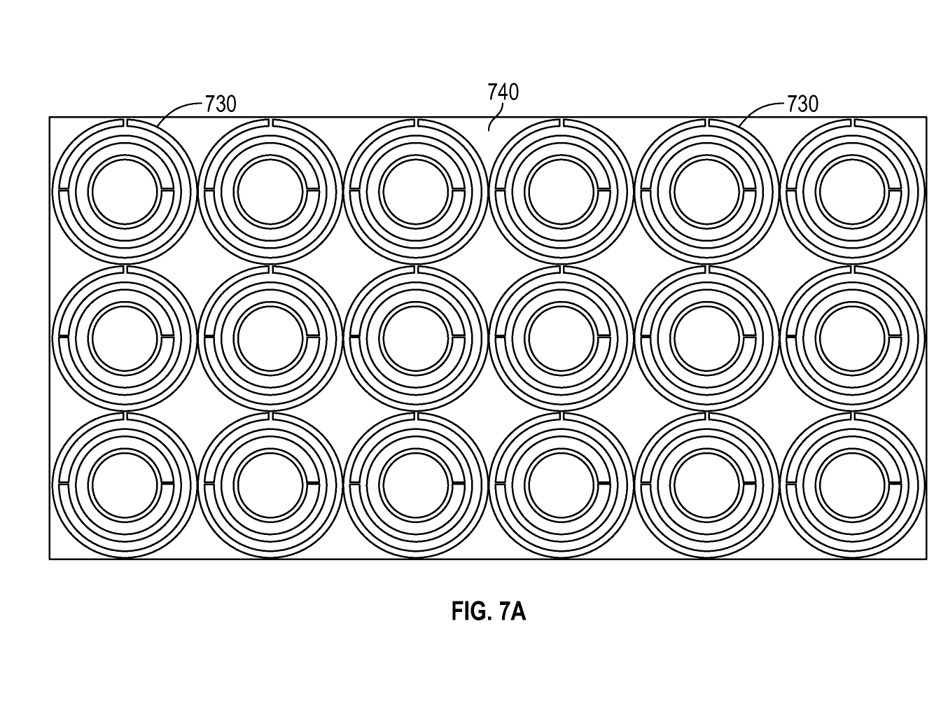

Turning to FIGS. 6A-6C, various configurations of shorteners that may be configured to reduce the standoff distance are shown. The shorteners 630a, 630b, 630c are configured to reduce the hydraulic diameter of a channel into which they may be inserted or incorporated or placed over at the inlet. Although only three configurations are shown herein, those of skill in the art will appreciate that many different geometries may be used to achieve a reduced hydraulic diameter in a channel. The shorteners 630a, 630b, 630c can be inserted into the hot side channels at the inlet where the recirculation zone occurs, e.g., at the channel inlets 310, 410, 510 shown in FIGS. 3-5. Each shortener may be configured to allow for thermal expansion and contraction of the shortener to limit stresses and strains in the hot side channels. Further, although shown as circular shorteners, those of skill in the art will appreciate that the shorteners may take any configuration and/or shape. In some non-limiting embodiments, the shorteners may be configured and/or shaped to match the configuration and/or shape of the channel inlet to which they may be attached.

With the application of the shorteners, the length of heat transfer down the channel length extending beyond the manifold interface surface, and from the shortener to the channel, may be reduced by making the outer width of the shortener slightly smaller than the inner width of the channel with a resultant air gap between the shortener outer width and channel inner width. Other embodiments may employ, in the alternative or in combination with the air gap, thin material and/or material with a low conductivity, such as ceramic or metal alloys. Those of skill in the art will appreciate that the channels of the manifold may include one or more flow passages. As such, one or more shorteners may be applied to the flow passages of the channels. One example purpose of the shorteners is to minimize the hydraulic diameter of all possible passages. Further, as shown in FIGS. 6A-6C, the shorteners may great multiple passages within the inlet, depending on the configuration of the shortener.

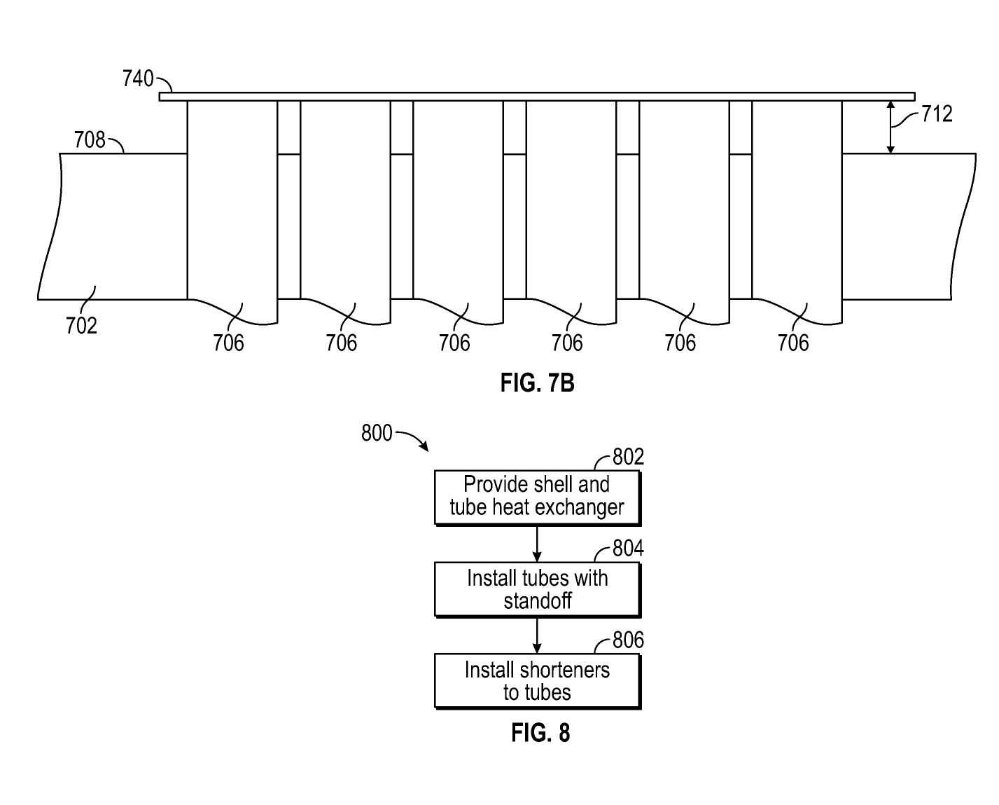

Turning to FIGS. 7A and 7B, schematic views of a configuration in accordance with an example embodiment of the present disclosure are shown. FIG. 7A shows a plan view of an example shortener configuration and FIG. 7B shows a side view thereof. In this example embodiment, the shorteners 730 are formed within or comprise a sheet 740. The sheet 740 may be positioned over a plurality of inlets of channels 706 such that each shortener 730 aligns with a respective inlet to a channel 706. In this configuration, a plurality of shorteners 730 may be installed with a respective plurality of channels 706. The sheet 740 may thus provide a shortening of the standoff distance 712 for all channels 706 that the sheet 740 overlays. In some embodiments, the sheet 740 may be configured to overlay all channels 706 within a manifold 702. As such, in accordance with some embodiments, a single sheet may be inserted into the manifold without the need to install a shortener within each and every channel individually.

Turning now to FIG. 8, a process of manufacturing a manifold is shown. The process 800 may be used to form a manifold, such as a high temperature heat exchanger similar to the manifolds shown and described above. The manifold, in accordance with process 800, provides reduced stresses near the channel-manifold interface, thus enabling more robust and long-life manifolds. Further, manifold manufactured in accordance with the process 800 may be lighter than other configurations because the shorteners may reduce the length of the channel standoff required to achieve a given manifold life, particularly for high temperature manifolds, such as shell and tube heat exchangers. Thus, the amount of channel material required in the manifold may be reduced as well as the amount of manifold material required by allowing the manifold diameter to be reduced.

At step 802, a manifold is provided. The manifold may include at least one manifold and a plurality of channels that are coupled to a body of the manifold. At step 804, a plurality of channels are installed into or with the manifold. The plurality of channels are positioned or set to have a standoff distance that is sufficient to minimize thermal stresses while minimizing the standoff. At step 806, the plurality of channels are provided with shorteners that are configured to enable the standoff distance to by minimal. The shorteners are provided to reduce the hydraulic diameters of the channels, thus enabling a shorter standoff distance. Although the process 800 is provided in a specific order, those of skill in the art will appreciate that the order may be varied or various steps may occur simultaneously and/or nearly simultaneously. Further, it will be appreciated that the various steps may define different techniques, such as described above. Moreover, additional steps may occur before, during, or after the above described process. For example, a step of depositing braze material and brazing the braze material to secure the channels to the manifold may be performed.

For example, step 804 may include installing a channel with an inlet having a reduced diameter, and thus the formation or manufacture of the channels may require a reduced diameter end, e.g., as shown in FIG. 4. Alternatively, step 804 may include installing the channels into a manifold having increased diameter apertures, and thus a process of counter-boring the interface surface of the manifold to generate holes that are configured to receive the channels that are larger diameter than the channels may be performed, e.g., as shown in FIG. 5.

Further, step 806 may include installing one shortener into each channel (e.g., FIGS. 6A-6C) or may include placing or installing a sheet that includes a plurality of shorteners thereon (e.g., FIGS. 7A-7B). Alternatively, step 806 may include manufacturing or pre-forming the channels with the shorteners integrally formed with the channels.

Regardless of the order of steps or how the various steps are carried out, the end result of process 800 is a manifold with thermal stress reduction features in the form of a standoff of the channels and/or the addition of a shortener in the channel. Such manifolds may include features that are shown and described above, or may include variations thereon. For example, the standoff may be of any desired length, the channels may have any desired geometries and/or configurations, and the shorteners may be configured with any desired geometries and/or configurations.

Advantageously, embodiments described herein provide manifolds with reduced low cycle fatigue and increased life. Advantageously, the features of the standoff and/or shorteners described herein may reduce the stresses on the manifold at the manifold-channel interface/junction, and thus cracks and/or leaks due to thermal stresses may be prevented. This may be achieved, in accordance with various embodiments, by reducing the stresses and strains due to thermal gradients near the interface between the channel and manifold. For example, the heat flux in regions near the entrance of the channel may be reduced and/or high heat flux regions may be moved away from the manifold-channel interface/junction.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, various geometries, configurations, distances, lengths, etc. may be used without departing from the scope of the present disclosure. Further, although some ratios and shapes are shown and described herein, these are provided as example and for illustrative purposes. Moreover, although shown and described with a standoff or a bore into the manifold, those of skill in the art will appreciate that any combination of standoff length and counter-bore depth may be used without departing from the scope of the present disclosure. Further, although shown with respect to a shell and tube heat exchanger, those of skill in the art will appreciate that embodiments described herein may be applied to any manifold, and may be applied to high-temperature manifolds as desired.

Accordingly, the present disclosure is not to be seen as limited by the foregoing description, but is only limited by the scope of the appended claims.

What is claimed is:

1. A manifold comprising:
a body defining a chamber configured to receive a fluid, the body having a plurality of apertures passing therethrough; and
a plurality of channels engaged in the apertures and configured to receive the fluid from the chamber, each of the plurality of channels having an end defining an inlet that is in fluid communication with the chamber,
wherein each channel defines a standoff defining a portion of the channel that is not in contact with the body such that the inlet is separated from the body by a standoff distance along the length of the channel, and
wherein the standoff distance is a distance that is one or more times a hydraulic diameter of the inlet.

2. The manifold of claim 1, further comprising a plurality of shorteners, each shortener coupled with a respective inlet of a channel of the plurality of channels, each shortener configured to reduce the hydraulic diameter of the channel at the inlet.

3. The manifold of claim 2, wherein the plurality of shorteners are connected to form a sheet.

4. The manifold of claim 2, wherein each shortener is integrally formed with the respective channel.

5. The manifold of claim 1, wherein the standoff is a section of channel that extends the standoff distance from a surface of the body.

6. The manifold of claim 1, wherein the standoff is at least partially defined by a standoff gap formed between an outer surface of the channel and the aperture.

7. The manifold of claim 6, wherein the channel comprises a reduced width portion, wherein the reduced width portion has a width that is smaller than a width of a respective aperture and the length of the reduced width portion is the standoff distance, wherein the standoff gap is formed between the reduced width portion and the aperture.

8. The manifold of claim 6, wherein the inlet of the channel is level with a surface of the body.

9. The manifold of claim 6, wherein each aperture defines a first portion having a first aperture width and a second portion having a second aperture width, wherein the first aperture width is larger than the outer surface of a respective channel, wherein the standoff gap is formed between the outer surface of the channel and the first portion.

10. The manifold of claim 9, wherein the first portion has a length equal to the standoff distance.

11. The manifold of claim 6, wherein the outer surface of the channel and the aperture have the same geometric shape.

12. The manifold of claim 1, wherein the standoff distance is a distance that is between three and six times a hydraulic diameter of the inlet.

13. The manifold of claim 1, wherein the body forms a manifold of a shell and tube heat exchanger and the channels form the tubes of the shell and tube heat exchanger.

14. A method of manufacturing a manifold, the method comprising:
providing a body defining a chamber configured to receive a fluid and having a plurality of apertures passing therethrough; and
installing a plurality of channels to engage with the apertures, each of the plurality of channels having an end defining an inlet that is in fluid communication with the chamber,
wherein, as installed, each channel defines a standoff defining a portion of the channel that is not in contact with the body such that the inlet is separated from the manifold by a standoff distance along the length of the channel, and
wherein the standoff distance is a distance that is one or more times a hydraulic diameter of the inlet.

15. The method of claim 14, further comprising installing a plurality of shorteners at the inlet of each channel, the shorteners configured to reduce the hydraulic diameter of the channel at the inlet.

16. The method of claim 15, wherein the plurality of shorteners are each connected to form a sheet, the method comprising installing the sheet into the manifold.

17. The method of claim 14, wherein the standoff is a section of channel that extends the standoff distance from a surface of the body.

18. The method of claim 14, wherein the standoff is at least partially defined by a standoff gap formed between an outer surface of the channel and the aperture.

19. The method of claim 18, wherein the inlet of the channel is level with a surface of the body.

20. The method of claim 14, wherein the body is a manifold for a shell and tube heat exchanger and the channels are the tubes of the shell and tube heat exchanger.
